(19) United States
(12) Patent Application Publication
(10) Pub. No.: US 2010/0281989 A1
(43) Pub. Date: Nov. 11, 2010

(54) PRESSURE SENSOR AND DEVICE FOR PREVENTING AIR INFLOW INTO THE PRESSURE SENSOR

(75) Inventors: Kum-Ja Kim, Gyeonggi-do (KR); Hyang-Gon Kim, Gyeonggi-do (KR)

Correspondence Address: DORITY & MANNING, P.A., POST OFFICE BOX 1449, GREENVILLE, SC, 29602-1449, US

(73) Assignee: ROLLPACK CO., LTD., Gyeonggi-do (KR)

(21) Appl. No.: 12/812,730

(22) PCT Filed: Nov. 24, 2008
(86) PCT No.: PCT/KR08/06928

§ 371 Date: Jul. 13, 2010

(30) Foreign Application Priority Data
Jan. 19, 2008 (KR) 1020080005940

(51) Int. Cl. G01L 7/00

(52) U.S. Cl. 73/706

(57) ABSTRACT

There are provided a pressure sensor sensing or measuring air pressure and a device for preventing air inflow, which is used to prevent air, moisture and foreign substances from flowing into the pressure sensor. The pressure sensor includes an air flow part through which air to be measured, the pressure of which is to be measured, flows, a pressure sensing part sensing the pressure of the air to be measured, which flows through the air flow part, and an air blocking part installed between the air flow part and the pressure sensing part, preventing the air to be measured from flowing into the pressure sensing part, and causing, at least, a movement or a deformation according to a pressure change of the air to be measured. The pressure sensor completely prevents moisture or foreign substances from flowing into the pressure sensor, thereby minimizing defects of the pressure sensor.

### TECHNICAL FIELD

The present invention relates to a pressure sensor, and more particularly, to a pressure sensor sensing or measuring air pressure and a device for preventing air inflow into the pressure sensor, which can prevent air, moisture and foreign substances from flowing into the pressure sensor.

### BACKGROUND ART

A pressure sensor is a device that measures pressure in a process or a system. The pressure sensor is one of the most widely used sensors, which is applied to a variety of uses such as industrial instrumentation, automatic control, medical service, automatic engine control, environmental control, and electric appliances.

The measuring principle of the pressure sensor uses displacement, deformation, magnetic-thermal heat conductivity, vibrations or the like. Many kinds of pressure sensors are in current use.

Examples of pressure sensors include mechanical pressure sensors using a Bourdon tube, a diaphragm or a bellows, an electronic pressure sensor converting mechanical displacement into an electrical signal, or a semiconductor pressure sensor.

FIGS. 1 through 3 illustrate one example of a mechanical pressure sensor that measures air pressure.

When the measured pressure reaches a specific pressure, the pressure sensor shown in FIGS. 1 through 3 generates an electric signal for cutting off or applying an electrical current.

Referring to FIGS. 1 and 2, the related art pressure sensor includes a lower housing 10, an upper housing 70, a sealing member 60 installed in an interior space between the lower and upper housings 10 and 70, and a conductive member 50 having electrical conductivity and attached under the sealing member 60. For example, the conductive member 50 may be attached to the sealing member 60 by inserting an insertion protrusion 61 of the sealing member 60 into a connection hole 51 disposed in the center of the conductive member 51.

An elastic member 40 in the form of a coil spring is placed on the lower housing 10 to provide an elastic force to the conductive member 50 and the sealing member 60.

A pair of connective members 20 are installed to pass through the lower housing 10. When the conductive member 50 descends against the elastic force of the elastic member 40, the connective members 20 contact the conductive member 50, forming an electrical connection. To make the heights of the connective members 20 uniform, the connective members 20 are exposed above the lower housing 10 through respective protrusions 12 protruding from an upper portion of the lower housing 10.

The sealing member 60 blocks air flow between the upper and lower sides. The upper housing 70 has an air hole 71 to allow the inflow of outside air into a space above the sealing member 60.

The related art pressure sensor may be used to measure air pressure. The operation of the related art pressure sensor will now be described in the case where air is sucked in a vacuum packing device using a vacuum pump, a vacuum processing device, a vacuum chamber or the like.

Referring to FIG. 2, the pressure sensor includes an air inlet tube 11 connected to a vacuum line where vacuum processing is performed. When air is sucked using a vacuum pump (not shown), the air in a space between the bottom of the sealing member 60 and the lower housing 10 is discharged through the air inlet tube 11, thereby lowering the pressure.

As the air pressure decreases, the sealing member 60 descends, overcoming the elastic force of the elastic member 40. When the pressure of the space reaches a set pressure, the conductive member 50 attached to the bottom of the sealing member 60 contacts the connective members 20 (see FIG. 3).

Thus, the pair of connective members 20 are electrically connected together and consequently send an electrical signal to the outside. Based on this electrical signal, the operation of the vacuum pump (not shown) may be stopped.

As described above, the related art pressure sensor may be used to stop the operation of the vacuum pump by sending out an electrical signal when the air pressure of the vacuum line becomes as low as a predetermined pressure or less.

The sealing member 60 ascends again to release the contact between the conductive member 50 and the connective members 20 when outside air is introduced into the vacuum line as the operation of the vacuum pump is stopped after the completion of the vacuum operation or the vacuum operation is not performed (see FIG. 2).

At this time, the vacuum line is in communication with the pressure sensor to allow air flow, which may cause moisture, foreign substances and the like to flow into the pressure sensor. This inflow of moisture and the like may occur more often when the vacuum state inside the pressure sensor is suddenly released, causing a rapid inflow of outside air.

Moisture or foreign substances flowing into the pressure sensor interrupt the descent of the sealing member 60 or result in defective contact between the connective members 20 and the conductive member 50. In this case, the pressure sensor completely fails to perform its function.

The limitation of the inflow of moisture or foreign substances to the pressure sensor may also arise with pressure sensors that measure pressure within a predetermined range, as well as the aforementioned pressure sensor reacting to specific pressure as shown in FIGS. 1 through 3.

Also, the above limitation may arise not only with mechanical pressure sensors but also with electrical pressure sensors if those pressure sensors serve to measure the air pressure.

A technique is demanded that can ensure the stable operation of pressure sensors which measure air pressure, by preventing moisture or foreign substances from flowing into the pressure sensor.

### DISCLOSURE OF INVENTION

### Technical Problem

The present invention has been made to solve the foregoing problems of the related art and therefore an aspect of the present invention is to provide a pressure sensor capable of preventing moisture or foreign substances from flowing therein when measuring air pressure, and a device for preventing air inflow, which is used in the pressure sensor.

### Technical Solution

According to an aspect of the present invention, there is provided a pressure sensor including: an air flow part through which air to be measured, the pressure of which is to be measured, flows; a pressure sensing part sensing the pressure of the air to be measured, which flows through the air flow part; and an air blocking part installed between the air flow part and the pressure sensing part, preventing the air to be measured from flowing into the pressure sensing part, and causing, at least, a movement or a deformation according to a pressure change of the air to be measured.

The pressure sensing part may cause, at least, a movement or a deformation by the pressure change of the air to be measured.

The sealed space cut off from the air to be measured may be formed between the pressure sensing part and the air blocking part.

The pressure sensing part may sense that the pressure of the air to be measured reaches a set pressure or lower.

The pressure sensing part may include: a sealing member installed inside a hollow housing; a conductive member having electrical conductivity and attached under the sealing member; and a connective member contacting the conductive member to be electrically connected when the pressure of the air to be measured reaches a set pressure or lower, wherein the sealed space may be formed between one side of the sealing member and the air blocking part.

The pressure sensing part may further include an elastic member providing an elastic force, preventing contact between the conductive member and the connective member when the pressure of the air to be measured is higher than the set pressure, and allowing the conductive member and the connective member to contact each other when the pressure of the air to be measured reaches the set pressure or lower. The pressure sensing part may further include an adjusting member adjusting the elastic force of the elastic member.

The elastic member may be a coil spring or a leaf spring, and the adjusting member may control the amount of deformation of the coil spring or the leaf spring.

The air blocking part may include an air blocking member installed inside a hollow housing to separate the air flow part from the pressure sensing part, and causing, at least, a movement or a deformation according to the pressure change of the air to be measured, and the pressure sensing part may include: a conductive member having electrical conductivity and installed to move together with the air blocking member and a connective member contacting the conductive member to form an electrical connection when the pressure of the air to be measured reaches a set pressure or lower. The conductive member may be fixed by being embedded in a connection shaft protruding upwardly from the air blocking member.

The hollow housing may include an air flow hole to expose the other side of the sealing member to outside air.

The pressure sensing part may measure the pressure of the air to be measured, which flows through the air flow part.

The air blocking part may include: a chamber having one side connected to the air flow part and the other side connected to the pressure sensing part; and an air blocking member installed inside the chamber to separate the air flow part from the pressure sensing part.

The air blocking member may be configured as a film member deformed by the pressure of the air to be measured, which flows through the air flow part.

The film member may have an outer edge fixed to an inner surface of the chamber and a central portion deformed by the pressure of the air to be measured.

The film member may have the outer edge insertedly fixed to a groove or a protrusion formed on the inner surface of the chamber. Alternatively, the film member may have the outer edge bonded and fixed to the inner surface of the chamber.

The air blocking member may be configured as a piston member moved along an inner surface of the chamber by the pressure of the air to be measured, which flows through the air flow part. A stopper may be formed on the inner surface of the chamber to restrict the movement of the piston member.

The film member may be formed of a more flexible material than that of the sealing member.

The film member may be deformed more sensitively to pressure changes of the air to be measured than the sealing member.

The pressure sensing part and the air blocking part may be formed as separate members and connected to each other by a connection tube.

The pressure sensing part and the air blocking part may be stacked inside a casing forming one interior space as a whole.

According to another aspect of the present invention, there is provided an air blocking device of a pressure sensor, the air blocking device including: a chamber having one side connected to an air flow part through which the air to be measured flows, and the other side connected to a pressure sensor measuring the pressure of the air to be measured; and an air blocking member installed inside the chamber to separate the air flow part from the chamber.

The air blocking member may be configured as a film member deformed by the pressure of the air to be measured, which flows through the air flow part. The film member may have an outer edge fixed to an inner surface of the chamber and a central portion deformed by the pressure of the air to be measured.

The air blocking member may be configured as a piston member moved along an inner surface of the chamber by the pressure of the air to be measured, which flows through the air flow part.

### Advantageous Effects

According to exemplary embodiments of the present invention, a sealed space formed between a pressure sensing part and an air blocking part due to the air blocking part prevents outside air from flowing into the sealed space, or the air blocking part prevents an air flow from the pressure sensing part. Accordingly, moisture and foreign substances are prevented from flowing into the pressure sensing part of a pressure sensor, thereby minimizing defects in the pressure sensor.

According to the present invention, the air blocking part is formed with simple construction, thereby reducing the need for the repair and replacement of the pressure sensor.

### BRIEF DESCRIPTION OF DRAWINGS

FIG. 1 is an exploded perspective view of a related art mechanical pressure sensor measuring air pressure.

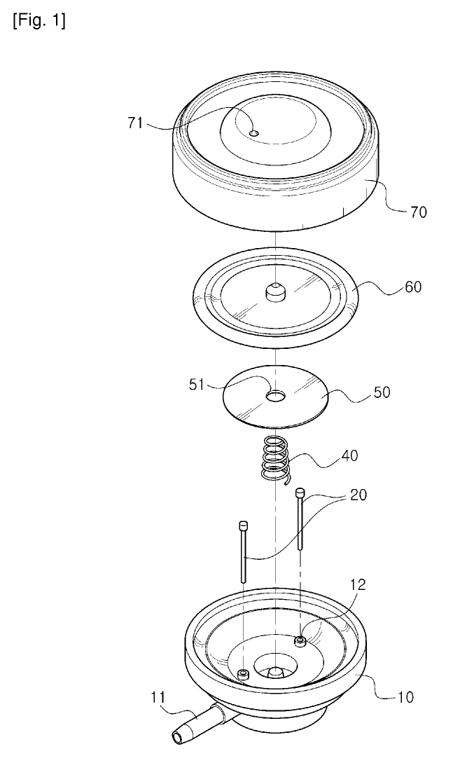

FIG. 2 is a cross-sectional view of the pressure sensor of FIG. 1.

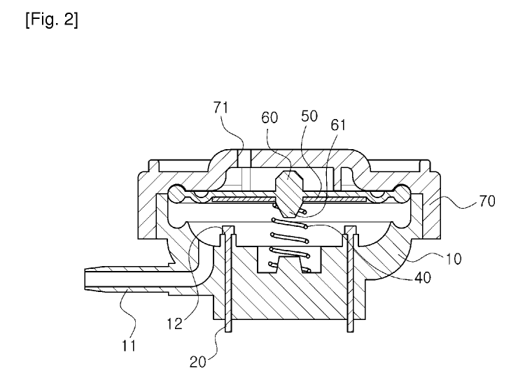

FIG. 3 is a cross-sectional view of the pressure sensor of FIG. 2, illustrating a signal generational state.

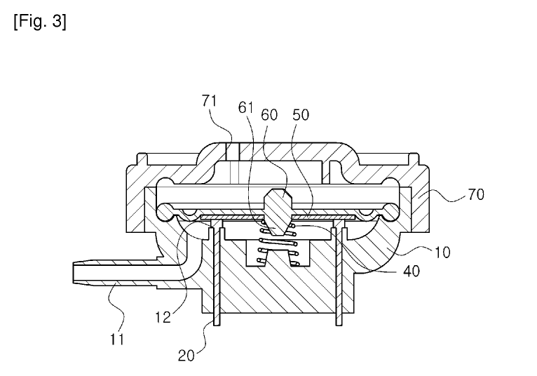

FIG. 4 is a cross-sectional view of a pressure sensor according to an exemplary embodiment of the present invention.

FIG. 5 is a cross-sectional view of the pressure sensor of FIG. 4, illustrating a signal generational state.

FIG. 6 is a schematic view of an air blocking part according to an exemplary embodiment of the present invention.

FIG. 7 is a schematic view of an air blocking part according to another exemplary embodiment of the present invention.

FIG. 8 is a schematic view of an air blocking part according to another exemplary embodiment of the present invention.

FIG. 9 is a cross-sectional view of a pressure sensor according to another exemplary embodiment of the present invention.

FIG. 10 is a cross-sectional view of the pressure sensor of FIG. 9, illustrating a signal generational state.

FIG. 11 is an exploded perspective view of a pressure sensor according to another exemplary embodiment of the present invention.

FIG. 12 is a cross-sectional view of the pressure sensor of FIG. 11.

FIG. 13 is a cross-sectional view of the pressure sensor of FIG. 12, illustrating a signal generational state.

### MODE FOR THE INVENTION

Hereinafter, exemplary embodiments of the present invention will be described in more detail with reference to accompanying drawings.

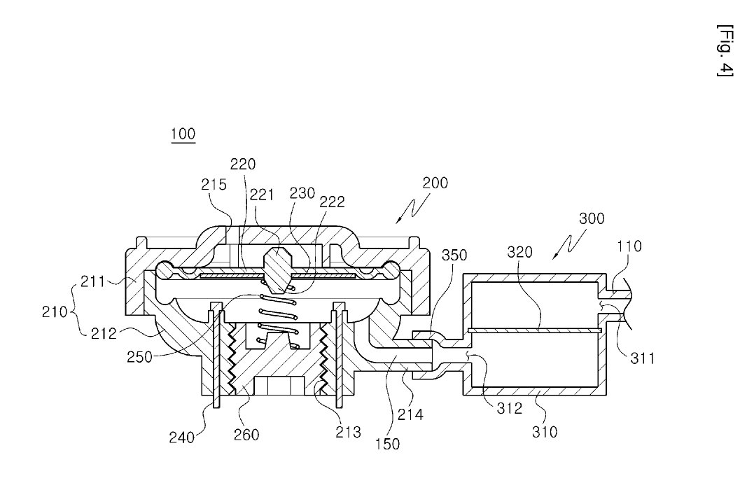

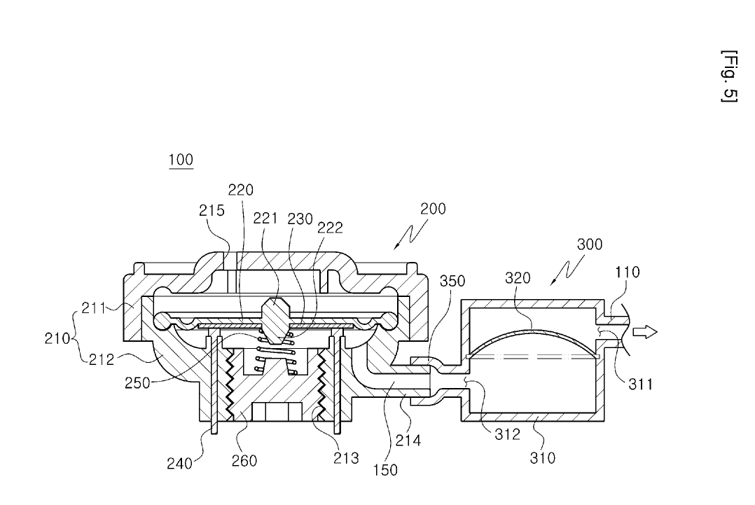

FIG. 4 is a cross-sectional view of a pressure sensor according to an exemplary embodiment of the present invention. FIG. 5 is a cross-sectional view of the pressure sensor of FIG. 4, illustrating a signal generational state.

As shown in FIGS. 4 and 5, a pressure sensor 100 measuring air pressure according to the present invention includes an air flow part 110 through which the air, the pressure of which is to be measured, flows (hereinafter, the air is referred to as the air to be measured), a pressure sensing part 200 sensing the pressure of the air to be measured, which flows through the air flow part 110, and an air blocking part 300 installed between the air flow part 110 and the pressure sensing part 200 to prevent the air to be measured from flowing into the pressure sensing part 200 while causing, at least, a movement or a deformation according to pressure changes of the air to be measured.

The air flow part 110 is connected to a tube (i.e., a vacuum line) through which the air to be measured, the pressure of which is to be measured, flows.

The pressure sensing part 200 includes a sealing member 220 installed inside a hollow housing 210, a conductive member 230 having electrical conductivity and attached under the sealing member 220 through a protrusion 222, and a pair of connective members 240 installed penetrating a lower housing 212 to contact the conductive member 230 to be electrically connected when the pressure of the air to be measured reaches a set pressure or less.

The sealing member 220 may be formed of a flexible material that easily deforms, such as rubber. However, the material of the sealing member 220 is not limited, provided that a sealed space can be formed under the sealing member 220. Also, the sealing member 220 may be formed of multiple materials. For example, different materials may be used for central and circumferential portions of the sealing member 220.

An elastic member 250 may be installed. The elastic member 250 provides an elastic force that prevents contact between the conductive member 230 and the connective members 240 when the pressure of the air to be measured is higher than a set pressure, and forces the conductive member 230 to contact the connective members 240 when the pressure of the air to be measured is as low as the set pressure or lower.

The elastic member 250 may be installed on a lower housing 212, but may be installed, connected to an adjusting member 260 if the adjusting member 260 is installed as will be described below.

The pressure sensing part 200 may include the adjusting member 260 that can adjust the set pressure to which the pressure sensor 100 reacts by controlling the elastic force of the elastic member 250. The adjusting member 260 may be threaded on a central portion of the lower housing 212. The adjusting member 260 is rotated to descend and ascend, thereby controlling the elastic force of the elastic member 250. This is advantageous in that the pressure to which the pressure sensing part 200 reacts can be controlled.

As shown in FIG. 4, the elastic member 250 may be configured as a coil spring. However, the elastic member 250 is not limited, provided that it can provide an elastic force to the sealing member 220 and the conductive member 230. For example, a leaf spring may be installed as the elastic member 250.

An air flow hole 215 may be formed in the upper housing 211 of the hollow housing 210 to expose an upper portion above the sealing member 220 to outside air. The air flow hole 215 prevents the formation of a vacuum space above the sealing member 220 when the sealing member 220 descends, thereby securing smooth movement of the sealing member 220.

The air blocking part 300 may include a chamber 310 having one side connected to the air flow part 110 and the other side connected to the pressure sensing part 200, and an air blocking member 320 installed in the chamber 310 to separate the air flow part 110 from the pressure sensing part 200.

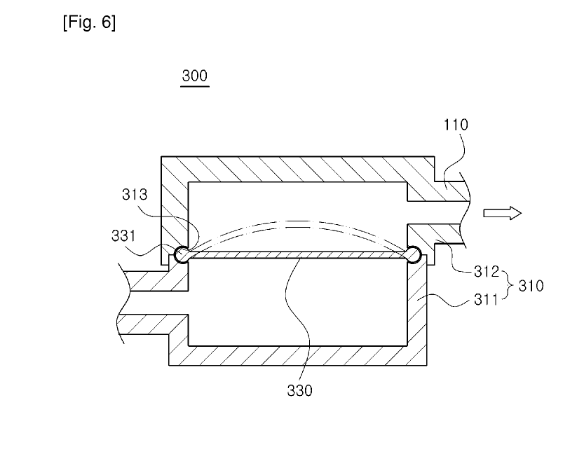

Exemplary embodiments of the air blocking part 300 will now be described with reference to FIGS. 6 through 8.

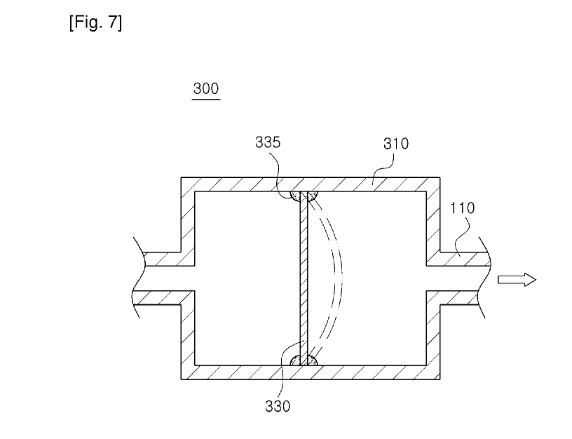

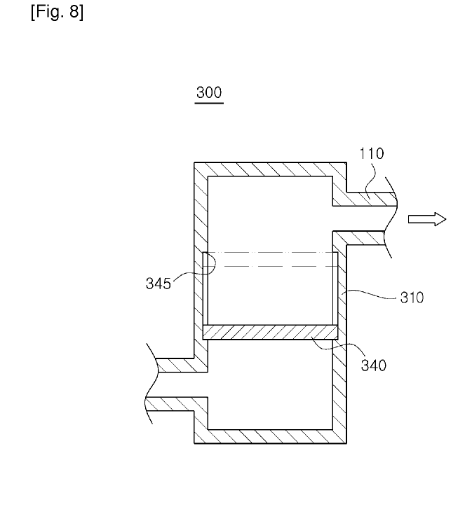

FIG. 6 is a schematic view of the air blocking part according to an exemplary embodiment of the present invention. FIG. 7 is a schematic view of the air blocking part according to another exemplary embodiment of the present invention. FIG. 8 is a schematic view of the air blocking part according to another exemplary embodiment of the present invention.

As described above, the air blocking part 300 includes a chamber 310 having one side 311 connected to the air flow part 110 and the other side 312 connected to the pressure sensing part 200, and an air blocking member 320 installed inside the chamber 310 to separate the air flow part 110 and the pressure sensing part 200 from each other.

As shown in FIGS. 6 and 7, the air blocking member 320 may be configured as a film member 330 deformed by the pressure of the air to be measured, which flows through the air flow part 110.

The film member 330 may have an outer edge 331 fixed to an inner surface of the chamber 310, and a central portion deformed by the pressure of the air to be measured.

As shown in FIG. 6, the film member 330 may be insertedly coupled to a groove 313 or a protrusion on an inner surface of the chamber 310 formed by two separate members 311 and 312. Alternatively, as shown in FIG. 7, the film member 330 may be fixed to the chamber 310 by being adhered to the inner surface of the chamber 310 through an adhesive unit 335.

The film member 330 is deformed when the air flows through the air flow part 110. For example, when the air is sucked through the air flow part 110 due to the operation of a vacuum pump, the film member 330 is curved toward the air flow part 110.

As shown in FIG. 8, the air blocking member 320 may be configured as a piston member 340 moved along the inner surface of the chamber 310 by the pressure of the air to be measured, which flows through the air flow part 110.

That is, the piston member 340 may be configured to slide toward the air flow part 110 when air is sucked through the air flow part 110 by the operation of a vacuum pump or the like. In this case, a stopper 345 or a guide may be formed on the inner surface of the chamber 310 to restrict the movement of the piston member 340. The location of the stopper 345 or the guide is adjustable according to the design pressure.

A sealed space 150 is formed between one side of the sealing member 220 and the air blocking part 300.

The sealed space 150 prevents an inflow of outside air through the air flow hole 215 or an inflow of the air to be measured through the air flow part 110. The sealed space 150 holds air of a predetermined volume.

The sealed space 150 holding the predetermined volume of air causes movement of the sealing member 220 due to the air blocking member 320 deforming or moving.

For example, when the air blocking member 320 deforms toward the air inflow side, the sealing member 220 moves in the same direction in which the air blocking member 320 deforms because the sealed space 150 contains air of the same volume and thus maintains a constant air pressure.

That is, the sealed space 150 is designed to maintain a constant air pressure (volume).

Thus, the sealing member 220 of the pressure sensing part 200 moves according to a pressure change of the air to be measured, so that the conductive member 230 contacts the connective members 240.

To allow the sealing member 220 to be smoothly moved by the deformation or movement of the air blocking member 320, the air blocking member 320 configured as the film member 330 or the like may be deformed more sensitively to the pressure change of the air to be measured, than the sealing member 220.

To this end, the film member 330 may be formed of a more flexible material than that of the sealing member 220. The material of the film member 330 is not limited, provided that it can easily deform according to changes in air pressure. Exemplary materials of the film member 330 may include rubber and a thin synthetic resin such as vinyl.

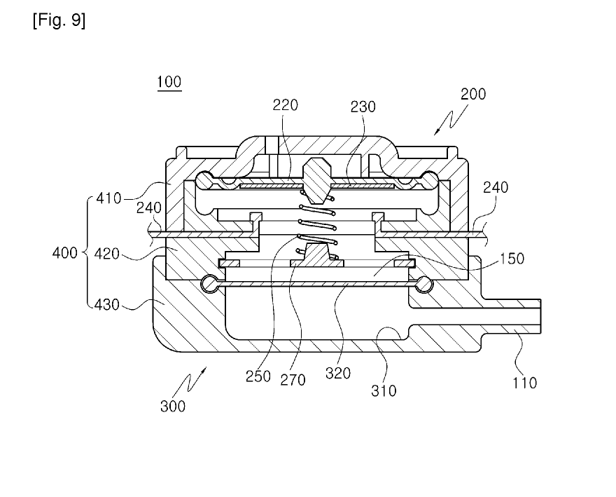

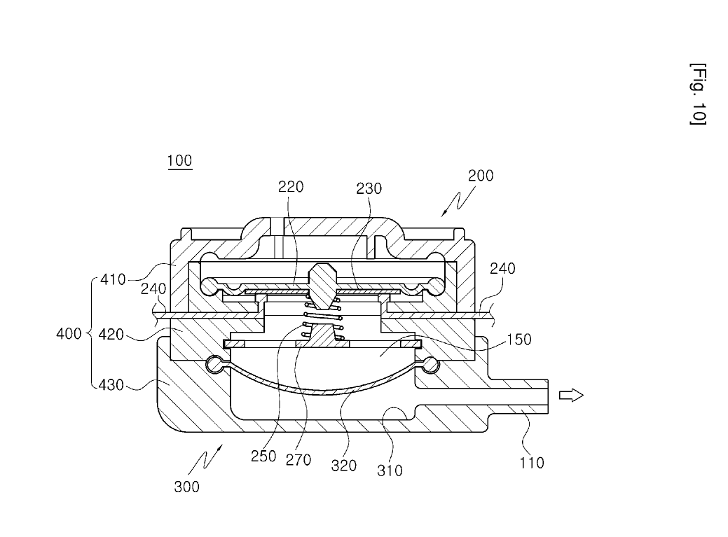

A pressure sensor according to another exemplary embodiment of the present invention will now be described with reference to FIGS. 9 and 10.

FIG. 9 is a cross-sectional view of a pressure sensor according to another exemplary embodiment of the present invention. FIG. 10 is a cross-sectional view of the pressure sensor of FIG. 9, illustrating a signal generational state.

In the pressure sensor 100 of FIGS. 9 and 10 measuring air pressure, the pressure sensing part 200 may be placed on the air blocking part 300 within a casing 400 that forms, as a whole, one interior space.

Like reference numerals in the drawings denote like elements, and to avoid unnecessary repetition of the description, only dissimilar parts to the embodiment of FIGS. 4 and 5 will be disclosed.

As shown in FIGS. 9 and 10, the pressure sensor 100 includes the pressure sensing part 200 and the air blocking part 300 stacked inside the casing 400. For the installation of various members, as shown in FIG. 9, the casing 400 may be formed by a plurality of separate members 410,420 and 430.

For the installation of the elastic member 250, a support member 270 may be installed in the sealed space 150. The support member 270 may have a hole for air flow within the sealed space 150.

In the pressure sensor of FIGS. 9 and 10, the pressure sensing part 200 and the air blocking part 300 are installed inside one casing 400. Thus, the sealed space 150 is formed between the pressure sensing part 200 and the air blocking part 300.

The operational effects of the pressure sensor measuring the air pressure according to the above exemplary embodiments will now be described using the case of vacuum processing as an example.

Referring to FIGS. 4, 5, 9 and 10, the pressure sensor 100 includes the air flow part 110 connected to a vacuum line in which vacuum processing is performed. When air is sucked using a vacuum pump (not shown), the air around the air flow part 110 within the chamber 310 is sucked through the air flow part 110. Thus, the pressure decreases around the air flow part 110, thereby deforming the air blocking member 320 toward the air flow part 110.

A sealed space formed between the air blocking member 320 and the sealing member 220 has a tendency to maintain a constant volume or pressure. For this reason, the sealing member 220 descends to cope with the deformation of the air blocking member 320.

As the pressure of the air is further decreased, the air blocking member 320 deforms more, and thus the sealing member 220 descends more. When the air to be measured reaches a set pressure, the conductive member 230 comes into contact with the connective members 240 as shown in FIG. 5. The contact between the connective members 240 and the conductive member 230 is sensed by a predetermined control unit (not shown) (e.g., an electrical signal is generated), so that the operation of the vacuum pump is stopped.

As described above, the air pressure is measured indirectly through the sealed space 150 without a direct inflow of the air to be measured to the pressure sensing part 200. Thus, moisture or foreign substances can be completely prevented from flowing into the pressure sensing part 200.

The pressure sensing part 200 has been described above as having a configuration to sense whether the pressure of the air to be measured, which flows through the air flow part 110, reaches a set pressure or lower. However, the pressure sensing part 200 may have a configuration to measure the pressure of the air to be measured. For example, the pressure sensing part 200 may have a configuration to measure a pressure value within a predetermined range, such as a general pressure sensor or a pressure gauge.

As shown in FIGS. 4 and 5, the pressure sensing part 200 and the air blocking part 300 may be formed as separate members and connected by a connection tube 350.

Alternatively, as shown in FIGS. 9 and 10, the pressure sensing part 200 and the air blocking part 300 may be stacked within the casing 400 that forms a single interior space as a whole.

As shown in FIGS. 4 and 5, the air blocking part 300 according to the present invention may be connected as a separate member to an existing pressure sensor for measuring the air pressure, and thus used as an air blocking device.

That is, referring to FIGS. 4 and 5, the chamber 310 has one side 311 connected to the air flow part 110 through which the air to be measured flows, and the other side 312 connected to an existing pressure sensor (illustrated in FIG. 4 as the pressure sensing part 200) for measuring the pressure of the air to be measured. The chamber 310 has therein a space with a predetermined size. The air blocking member 320 is installed inside the chamber 310 to separate the air flow part 110 from the chamber 310.

Such an air blocking device has the same construction as the air blocking part 300 described with reference to FIGS. 4 through 8. Thus, the detailed description of the air blocking device will be omitted to avoid unnecessary repetition.

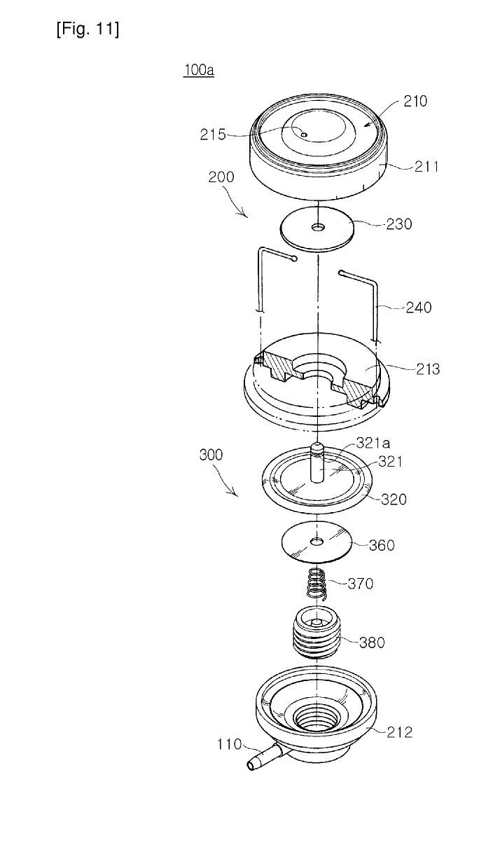

A pressure sensor according to another exemplary embodiment of the present invention will now be described with reference to FIGS. 11 through 13.

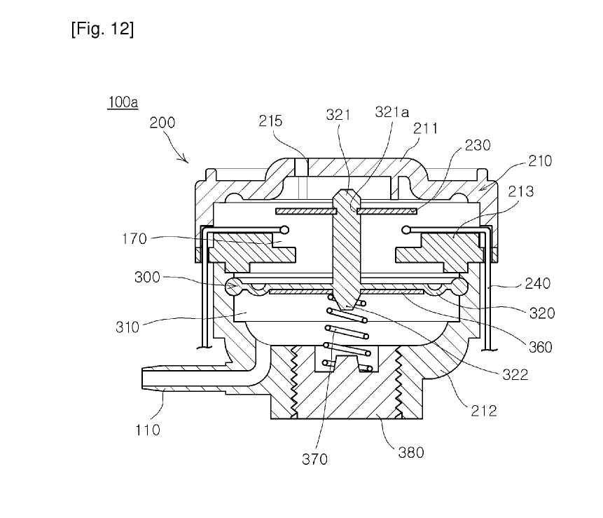

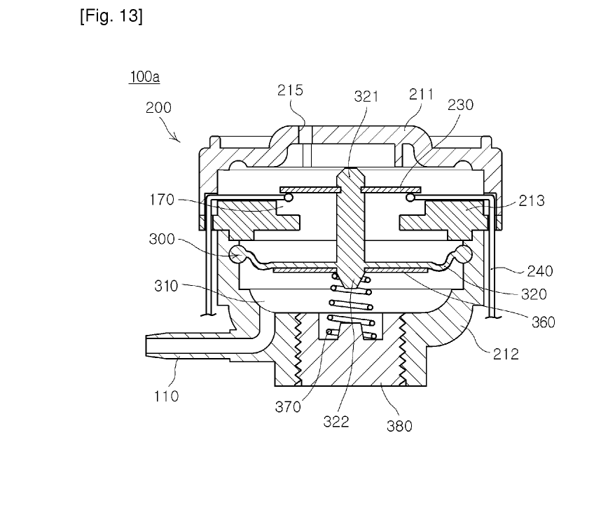

FIG. 11 is an exploded perspective view of a pressure sensor according to another exemplary embodiment of the present invention. FIG. 12 is a cross-sectional view of the pressure sensor of FIG. 12, and FIG. 13 is a cross-sectional view of the pressure sensor of FIG. 12, illustrating a signal generational state.

Like reference numerals in the drawings denote like elements, and to avoid unnecessary repetition of the description, only dissimilar parts to the embodiments of FIGS. 4, 5, 9 and 10 will be disclosed.

Referring to FIGS. 11 through 13, a pressure sensor 100a according to this embodiment, like the embodiments of FIGS. 4 through 10, includes an air flow part 110, a pressure sensing part 200, and an air blocking part 300.

The air flow part 110, the pressure sensing part 200 and the air blocking part 300 may be installed inside a hollow housing 210 including an upper housing 211, a middle housing 213, and a lower housing 212 to form a space with a predetermined size therein. The air flow part 110 may be installed to be connected to, e.g., the lower housing 212.

In the space inside the hollow housing 210, the air blocking part 300 is installed between the air flow part 110 and the pressure sensing part 200. The air blocking part 300 serves to block inflow of the air to be measured from the air flow part 110 to the pressure sensing part 200.

The air blocking part 300 includes an air blocking member 320 separating the air flow part 110 from the pressure sensing part 200. The air blocking member 320 moves according to the pressure change of the air to be measured from the air flow part 110.

As described with reference to FIGS. 6 through 8, the air blocking member 320 may be configured as a film member (see 330 of FIGS. 6 and 7) that is deformed by the pressure of the air to be measured, which flows through the air flow part 110 (see FIGS. 6, 7 and 11 through 13). Alternatively, the air blocking member 320 may be con figured as a piston member (see 340 of FIG. 8) that is moved along an inner surface of the chamber 310 by the pressure of the air to be measured, which flows through the air flow part 110. Detailed descriptions of the film member 330 and the piston member 340 will be omitted since they have been described with reference to FIGS. 6 through 8.

The pressure sensing part 200 may include a conductive member 230 and connective members 240. The conductive member 230 has electrical conductivity and is installed to move with air blocking member 320. The connective members 240, when the pressure of the air to be measured reaches a set pressure or lower, contacts the conductive member 230 to be electrically connected thereto.

The conductive member 230 is inserted and fixed to a groove 321a formed in a connection shaft 321 protruding upwardly from the air blocking member 320, so that the conductive member 230 moves together with the air blocking member 320. As shown in FIG. 12, the connective members 240 may be installed above the middle housing 213. However, the installation location of the connective members 240 is not limited, provided that they can contact the conductive member 230 moved by the movement of the air blocking member 320. An air flow hole 215 is formed in the upper casing 211 of the hollow housing 210 to expose one side of a sealing member to outside air. The air flow hole 215 prevents a decrease in the pressure of a space 170 above the air blocking member 320 when the air blocking member 320 descends. Thus, the air flow hole 215 ensures the smooth movement of the air blocking member 320

The air blocking part 300 installed in the pressure sensor 100a of FIGS. 11 through 13 may further include an elastic member 370 that elastically supports the air blocking member 320. An elasticity support member 360 may be provided between the air blocking member 320 and the elastic member 370 in order to support an elastic force of the elastic member 370, that is, to prevent the air blocking member 320 from being deformed by the elastic force of the elastic member 370. A support protrusion 322 may be formed under the air blocking member 320 for the installation of the elasticity support member 360 and the elastic member 370. The elastic member 370 may be a coil spring or a leaf spring as described in the above embodiments.

The air blocking part 300 may further include an adjusting member 380 to control the elastic force of the elastic member 370. The adjusting member 380 rotates along a screw thread formed on the lower housing 212, thereby controlling the pressing force of the elastic member 320 pressing the air blocking member 320. However, a method for the adjusting member 380 to control the pressing force of the elastic member 370 is not limited to the description. The adjusting member 380 can control the conductive member 230 to contact the connective member 240 at a specific pressure when the conductive member 230 is moved by the movement of the air blocking member 320, so that the pressure sensing part 200 can be controlled to sense the specific pressure.

The operational effects of the pressure sensor 100a of FIGS. 11 through 13 will now be described.

As shown in FIG. 12, in the pressure sensor 100a, the air flow part 110 is connected to a vacuum line where vacuum processing is performed. When air is sucked with a vacuum pump (not shown), the air close to the air flow part 110 within the chamber 310 is sucked through the air flow part 110. This lowers the pressure around the air flow part 110, causing the deformation of the air blocking member 320 toward the air flow part 110 (see FIG. 13). Thus, the conductive member 230 fixed above the air blocking member 320 descends.

As the pressure of the air to be measured keeps decreasing, the air blocking member 320 deforms further toward its lower side, and thus the conductive member 230 descends further. When the air to be measured is at a set pressure, the conductive member 230 contacts the connective members 240 as shown in FIG. 13. Then, the contact between the connective members 240 and the conductive member 230 is sensed by a predetermined control unit (not shown) (e.g., an electrical signal is generated), thereby stopping the operation of the vacuum pump.

Since the air to be measured does not flow directly through the pressure sensing part 200, moisture or foreign substances can be completely prevented from flowing into the pressure sensing part 200.

While the present invention has been shown and described in connection with the exemplary embodiments, it will be apparent to those skilled in the art that modifications and variations can be made without departing from the spirit and scope of the invention as defined by the appended claims.

1. An air pressure sensor comprising:
an air flow part through which air to be measured flows;
a pressure sensing part including a sealing member installed inside a hollow housing having an air flow hole formed at the upper side of the hollow housing to expose one side of the sealing member to outside air, a conductive member having electrical conductivity and attached under the sealing member, and a connective member contacting the conductive member to be electrically connected thereto when the pressure of the air to be measured reaches a set pressure or lower; and
an air blocking part including an air blocking member installed between the air flow part and the pressure sensing part, preventing the air to be measured from flowing into the pressure sensing part, and causing, at least, a movement or deformation according to a pressure change of the air to be measured,
wherein the conductive member and the connective member are formed into a sealed space located between the sealing member and the air blocking member and the conductive member and the sealing member, which form both sides of the sealed space are moved or deformed by the pressure change of the air to be measured flowing through the air flow part, whereby the contact between the connective member attached to the sealing member and the conductive member is formed.

2. (canceled)

3. (canceled)

4. (canceled)

5. (canceled)

6. The air pressure sensor of claim 1, wherein the pressure sensing part further comprises an elastic member providing an elastic force to prevent contact between the conductive member and the connective member when the pressure of the air to be measured is higher than the set pressure, and to allow the conductive member and the connective member to contact each other when the pressure of the air to be measured reaches the set pressure or lower.

7. The air pressure sensor of claim 6, wherein the pressure sensing part further comprises an adjusting member adjusting the elastic force of the elastic member.

8. The air pressure sensor of claim 7, wherein the elastic member is a coil 14 spring or a leaf spring, and the adjusting member controls the amount of deformation of the coil spring or the leaf spring.

9. An air pressure sensor comprising:
an air flow part through which air to be measured flows;
a pressure sensing part sensing the pressure of the air to be measured; and
an air blocking part installed between the air flow part and the pressure sensing part, preventing the air to be measured from flowing into the pressure sensing part, and causing, at least a movement or a deformation according to a pressure change of the air to be measured,
wherein the air blocking part comprises an air blocking member installed inside a hollow housing having an air flow hole formed at the upper side of the hollow housing to expose the upper side of the air blocking member to outside air,
wherein the air blocking member separates the air flow part from the pressure sensing part and is moved or deformed by the pressure change of the air to be measured,
the pressure sensing part comprising:
a conductive member having electrical conductivity and installed at the upper side of the air blocking member to move together with the air blocking member; and
a connective member contacting the conductive member to form an electrical connection when the pressure of the air to be measured reaches a set pressure or lower,
wherein the air blocking member has an upper side in communication with outside air flowing through the air flow hole and a lower side in communication with the air to be measured flowing through the air flow part, and is moved or deformed by a pressure difference between the air to be measured and the outside air, whereby the contact between the connective member and the conductive member is formed.

10. (canceled)

11. (canceled)

12. The air pressure sensor of claim 1, wherein the air blocking part comprises:
a chamber having one side connected to the air flow part and the other side connected to the pressure sensing part; and
an air blocking member installed inside the chamber to separate the air flow part from the pressure sensing part.

13. The air pressure sensor of claim 9, wherein the air blocking member is configured as a film member deformed by the pressure of the air to be measured, which flows through the air flow part.

14. (canceled)

15. (canceled)

16. (Cancelled)

17. An air pressure sensor comprising:
an air flow part through which air to be measured flows;
a pressure sensing part sensing the pressure of the air to be measured; and
an air blocking part including a chamber having one side connected to the air flow part and the other side connected to the pressure sensing part, and an air blocking member installed inside the chamber to separate the air flow part from the pressure sensing part and preventing the air to be measured from flowing into the pressure sensing part, and causing, at least, a movement or a deformation according to a pressure change of the air to be measured,
wherein the air blocking member is configured as a piston member moved along an inner surface of the chamber by the pressure of the air to be measured.

18. The air pressure sensor of claim 17, wherein a stopper is formed on the inner surface of the chamber to restrict the movement of the piston member.

19. The air pressure sensor of claim 1, wherein the air blocking part comprises:
a chamber having one side connected to the air flow part and the other side connected to the pressure sensing part; and
a film member installed inside the chamber to separate the air flow part from the pressure sensing part and having an outer edge fixed to an inner surface of the chamber and a central portion deformed by the pressure of the air to be measured, the film member being formed of a more flexible material than that of the sealing member.

20. The air pressure sensor of claim 1, wherein the air blocking part comprises:
a chamber having one side connected to the air flow part and the other side connected to the pressure sensing part; and
a film member installed inside the chamber to separate the air flow part from the pressure sensing part and having an outer edge fixed to an inner surface of the chamber and a central portion deformed by the pressure of the air to be measured, the film member being deformed more sensitively to pressure changes of the air to be measured than the sealing member.

21. The air pressure sensor of claim 1, wherein the pressure sensing part and the air blocking part are formed as separate members and connected to each other by a connection tube.

22. The air pressure sensor of claim 1, wherein the pressure sensing part and the air blocking part are stacked inside a casing forming one interior space.

23. The air pressure sensor of claim 9, wherein the conductive member is fixed by being embedded in a connection shaft protruding upwardly from the air blocking member.

24. The air pressure sensor of claim 9, wherein the air blocking part further comprises an elastic member elastically supporting the air blocking member.

25. The air pressure sensor of claim 24, wherein the air blocking part comprises an elasticity support member installed between the air blocking member and the elastic member to support an elastic force of the elastic member.

26. The air pressure sensor of claim 24, wherein the air blocking part further comprises an adjusting member adjusting the elastic force of the elastic member.

27. The air pressure sensor of claim 26, wherein the elastic member is configured as a coil spring or a leaf spring, and the adjusting member adjusts the amount of deformation of the coil spring or the leaf spring.

28. An air blocking device of a pressure sensor, the air blocking device comprising:
a chamber having one side connected to an air flow part through which the air to be measured flows, and the other side connected to a pressure sensor measuring the pressure of the air to be measured; and
an air blocking member installed inside the chamber to separate the air flow part from the chamber.

29. The air blocking device of claim 28, wherein the air blocking member is configured as a film member deformed by the pressure of the air to be measured, which flows through the air flow part.

30. The air blocking device of claim 29, wherein the film member has an outer edge fixed to an inner surface of the chamber and a central portion deformed by the pressure of the air to be measured.

31. The air blocking device of an air pressure sensor, the air blocking device comprising:
a chamber having one side connected to an air flow path through which the air to be measured flows, and the other side connected to a pressure sensor measuring the pressure of the air to be measured; and
an air blocking member installed inside the chamber to separate the air flow part from the pressure sensor, wherein the air blocking member is configured as a piston member moved along an inner surface of the chamber by the pressure of the air to be measured.
